(19) United States
(12) Patent Application Publication
(10) Pub. No.: US 2013/0212306 A1
(43) Pub. Date: Aug. 15, 2013

(54) HOST DEVICE DISPLAY DEVICE AND DATA TRANSMISSION METHOD THEREOF

(71) Applicant: Chien-Hung LIU, New Taipei City (TW)

(72) Inventor: Chien-Hung LIU, New Taipei City (TW)

(73) Assignee: QUANTA COMPUTER INC., Tao Yuan Shien (TW)

(21) Appl. No.: 13/461,884

(22) Filed: May 2, 2012

(30) Foreign Application Priority Data
Feb. 10, 2012 (TW) 101104435

(51) Int. Cl. G06F 13/12

(52) U.S. Cl. 710/72

(57) ABSTRACT

A host device includes a processing core, a switch, and a host-end universal serial bus (USB) connector. The processing core provides a display signal and a USB signal to the switch. The host-end USB connector is selectively connected to a video USB (VUSB) display device and a USB peripheral device. The processing core has the switch controlled to output the display signal via the host-end USB connector, when the host-end USB connector is connected to a VUSB display device. The processing core has the switch controlled to output the USB signal via the host-end USB connector, when the host-end USB connector is connected to a USB peripheral device.

This application claims the benefit of Taiwan application Serial No. 101104435, filed Feb. 10, 2012, the subject matter of which is incorporated herein by reference.

### BACKGROUND OF THE INVENTION

1. Field of the Invention

The invention relates in general to a host device, a display device and an image data transmission method, and more particularly to a host device using a universal serial bus (USB) connector for transmitting image data, a display device and an image data transmission method.

2. Description of the Related Art

The universal serial bus (USB) transmission protocol, having the features of plug and play, high supportability and high transmission efficiency, has been widely used in various electronic products such as portable hard disk, keyboard, mouse, printer and other peripheral devices. In addition to the user control interface already disposed in a host device such as personal computer, notebook computer, and Tablet PC, the USB connector has gradually become a standard accessory to the host device for increasing the application and augmentation of the host device.

The current trend for the appearance of mobile computer is directed towards slimness, lightweight and compactness. Under such trend, the available space for the disposition of an I/O connector on the casing of a notebook computer or Tablet PC is further restricted. Therefore, how to provide an I/O connector which is more flexible in use and capable of supporting the data transmission for more peripheral devices has become an imminent task for the industries.

### SUMMARY OF THE INVENTION

According to a first aspect of the present invention, a host device including a processing core, a switch and a host-end universal serial bus (USB) connector is provided. The processing core provides a display signal and a USB signal. The switch receives the display signal and the USB signal. The host-end USB connector is coupled to the switch, and is selectively connected to one of a display device and a USB peripheral device. When the host-end USB connector is connected to the display device, the processing core provides a first selection signal for controlling the switch to output the display signal via the host-end USB connector, so that the host device may drive the display device to display the display signal. When the host-end USB connector is connected to the USB peripheral device, the processing core provides a second selection signal for controlling the switch to output the USB signal via the host-end USB connector, so that the host device may exchange the USB signal with the USB peripheral device.

According to a second aspect of the present invention, a display device including a display unit, a control unit and a slave-end USB connector is provided. The display unit includes a display connector for providing a display integrated information. The control unit is coupled to the display connector for receiving the display integrated information. The slave-end USB connector is coupled to the display connector and the control unit, and is selectively connected to the host device. When the integrated the slave-end connector is connected to the host device, the control unit provides a display-end response signal to the host device according to the display integrated information. The host device, in response to the display-end response signal, provides a display signal via the slave-end USB connector for driving the display unit to display the display signal.

According to a third aspect of the present invention, an image data transmission method is provided. The method is used in a host device including a host-end USB connector, a switch and a processing core. The image data transmission method includes the following steps. Firstly, whether an external device is connected to the host-end USB connector is determined by the processing core. If so, whether a USB protocol signal can be received via the host-end USB connector is determined by the processing core. When the USB protocol signal can be received, the processing core determines the external device as a USB peripheral device, and drives the switch to provide a USB signal to the host-end USB connector, so that the host device may exchange the USB signal with the USB peripheral device. When the USB protocol signal cannot be received, the processing core determines whether a display-end response signal can be received via the host-end USB connector. If so, the processing core determines the external device as a display device, and drives the switch to provide a display signal to the host-end USB connector for driving the external device to display the display signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a host device according to an embodiment of the invention;

FIG. 2 shows a block diagram of a host-end USB connector 105 according to an embodiment of the invention;

FIG. 3 shows a block diagram of a switch 103 according to an embodiment of the invention;

FIG. 4 shows a block diagram of a manual switch 107 according to an embodiment of the invention;

FIG. 5 shows a block diagram of a display device according to an embodiment of the invention;

FIG. 6 shows a block diagram of a display connector 21 according to an embodiment of the invention;

FIG. 7 shows a circuit diagram of a control unit 203.

FIG. 8 shows a circuit diagram of a slave-end USB connector 205;

FIG. 9 shows a flowchart of an image data transmission method according to an embodiment of the invention.

### DETAILED DESCRIPTION OF THE INVENTION

The host device of the present embodiment of the invention is equipped with a video universal serial bus (VUSB). The host device is selectively connected to one of a display device and a universal serial bus (USB) peripheral device for performing the exchange of display data and auxiliary display data or the exchange of USB signal via the USB connector.

### Host Device:

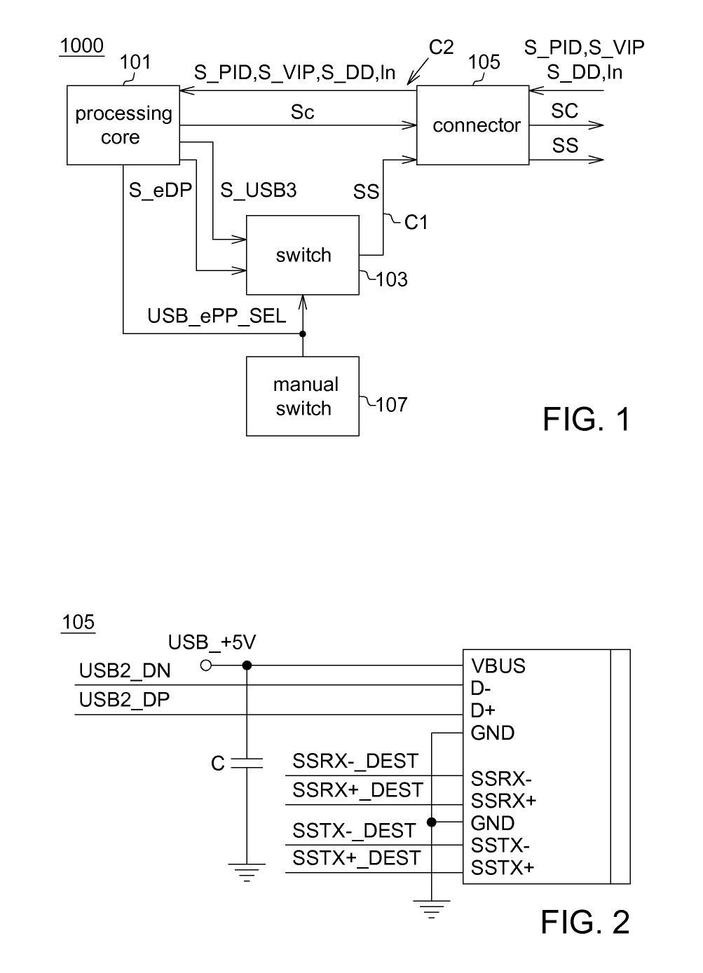

Referring to FIG. 1, a block diagram of a host device according to an embodiment of the invention is shown. The computer system of the present embodiment of the invention includes a host device 1000. The host device 1000 includes a processing core 101, a switch 103 and a host-end USB connector 105. The host-end USB connector 105 is connected to the switch 103 and the processing core 101, and the switch 103 is connected to the processing core 101.

Referring to FIG. 2, a block diagram of a host-end USB connector 105 according to an embodiment of the invention is shown. The host-end USB connector 105, such as a USB 3.0 connector, includes a first USB pin group and a second USB pin group. Furthermore, the first USB pin group, used as a USB 3.0 transmission lane, includes pins SSRX−, SSRX+, GND, SSTX+ and SSTX−. The first USB pin group is connected to the switch 103 via the USB 3.0 transmission line C1 for correspondingly receiving a USB signal S_USB3. The second USB pin group, used as a USB 2.0 transmission lane, includes pins VBUS, D−, D+ and GND. The second USB pin group is connected to the processing core 101 via the USB 2.0 transmission line C2.

The processing core 101 provides display signals S_eDP and S_USB3. The display signal S_eDP, such as an embedded display port (eDP) image signal having two lanes, includes the following components, namely, eDP_TX0+, eDP_TX0−, eDP_TX1+ and eDP_TX1−. The USB signal S_USB3 is a USB signal conformed to USB 3.0 standard. The USB signal S_USB3 includes the following components, namely, VBUS, GND, USB3 TX+, USB3_TX−, USB3_RX+ and USB3_RX−. The USB 2.0 lane includes the following components, namely, VBUS, GND, USB2_DP and USB2_DN.

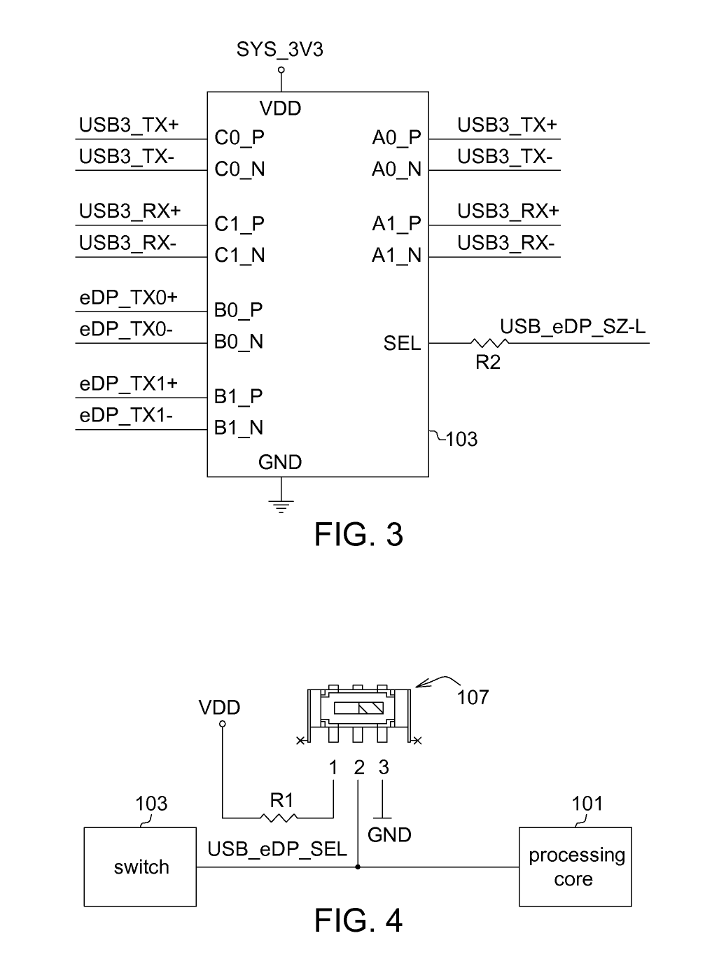

Referring to FIG. 3, a block diagram of a switch 103 according to an embodiment of the invention is shown. The switch 103 receives the display signal S_eDP and the USB signal S_USB3 from the processing core 101, and, in response to the selection signal USB_eDP_SEL received by the pin SEL, selectively outputs one of the display signal S_eDP and the USB signal S_USB3 as an output signal SS. For example, the output signal includes the following components, namely, SSTX+_DEST, SSTX−_DEST, SSRX+_DEST and SSRX−_DEST. For example, the selection signal USB_eDP_SEL is provided by the processing core 101.

When an external device is connected to the host device 1000, the processing core 101 is connected to the host device 1000 via the host-end USB connector 105 for correspondingly determining whether the external device is a peripheral device conformed to USB 3.0 protocol by determining whether the signal is conformed to USB 3.0 protocol is received by the first pin group (that is, the pins corresponding to the USB 3.0 signal).

When a signal conformed to USB 3.0 protocol is received by the first USB pin group, this indicates that the external device is an ordinary peripheral device conformed to USB 3.0 protocol. Thus, the processing core 101 correspondingly determines that the host-end USB connector 105 is connected to an ordinary USB peripheral device, and accordingly provides a selection signal USB_eDP_SEL corresponding to the first level for controlling the switch 103 to output the USB signal S_USB3 as an output signal SS. Thus, the host device 1000 may exchange USB signals with the USB peripheral device. For example, the first level corresponds to the level of the supply voltage VDD.

Conversely, when the first USB pin group does not receive any signals conformed to USB 3.0 protocol, the processing core 101 further communicates with the external device via the second pin group (that is, the pin group corresponding to the USB 2.0 lane) for determining whether the external device is a display device conformed to VUSB protocol by determining whether the external device correspondingly sends back the display-end response signal. For example, the display device response signal, transmitted via the USB 2.0, includes the product identity S_PID, the vendor identity (Vendor ID) S_VID and the device descriptions S_DD of an external device. The processing core 101 may determine whether the external device supports VUSB protocol according to the foregoing information (such as by looking up a table).

When the display-end response signal is received via the USB 2.0 lane, this indicates that the external device is a display device conformed to VUSB protocol. Thus, the processing core 101 correspondingly determines that the host-end USB connector 105 is connected to the VUSB display device, and accordingly provides the selection signal USB_eDP_SEL corresponding to the second level for controlling the switch 103 to output the eDP signal S_eDP as an output signal SS. For example, the second level corresponding to the level of the ground voltage GND. In addition, the processing core 101 further provides a control signal SC via the USB 2.0 lane for controlling the external device to boot the system to perform associated display operations. Thus, the host device 1000 may correspondingly drive the VUSB display device to perform a display operation with respect to the display signal S_eDP.

Conversely, when the display-end response signal cannot be received via the USB 2.0 lane, this indicates that the external device is not a display device conformed to VUSB protocol but may be realized by a USB peripheral device supporting USB 2.0 protocol. Thus, the processing core 101 does not make adjustment with respect to the switch 103, but communicates with the external device via the USB 2.0 lane.

In an example, the host device 1000 may further include a manual switch 107, which determines the level of the selection signal USB_eDP_SEL in response to the user's switch operation as indicated in FIG. 4.

Furthermore, the manual switch 107 includes pin #1, pin #3 and pin #2. The pin #1 receives the supply voltage VDD. The pin #3 receives the ground voltage GND. The pin #2 is coupled to the pin SEL of the switch 103. The manual switch 107 further connects the pin #1 and the pin #2 by way of short-circuiting in response to the first user-triggered operation event, so that the pin SEL is correspondingly biased to the supply voltage VDD. Thus, the manual switch 107 has the switch 103 controlled to output the display signal S_eDP via the host-end USB connector 105.

Conversely, the manual switch 107 further connects the pin #3 and the pin #2 by way of short-circuiting in response to the second user-triggered operation event, so that the pin SEL is correspondingly biased to the ground voltage GND. Thus, the manual switch 107 has the switch 103 controlled to output the USB signal S_USB3 via the host-end USB connector 105.

Under the circumstances that the processing core 101 has not resumed normal operations (for example, the booting procedure is not completed), the user still may control the functions supported by the host-end USB connector 105.

### Display Device:

Detailed descriptions of the display device supporting VUSB function mentioned in the foregoing disclosure of the host device are disclosed in an example below.

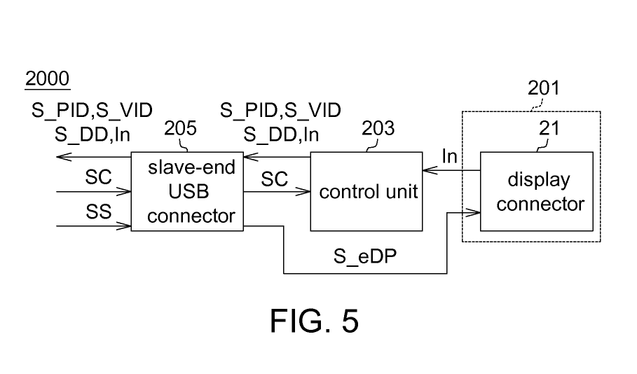

Referring to FIG. 5, a block diagram of a display device according to an embodiment of the invention is shown. The display device 2000 such as includes a display unit 201, a control unit 203 and a slave-end USB connector 205. The slave-end USB connector 205 is connected to the control unit 203 and the display unit 201. The control unit 203 is further connected to the display unit 201.

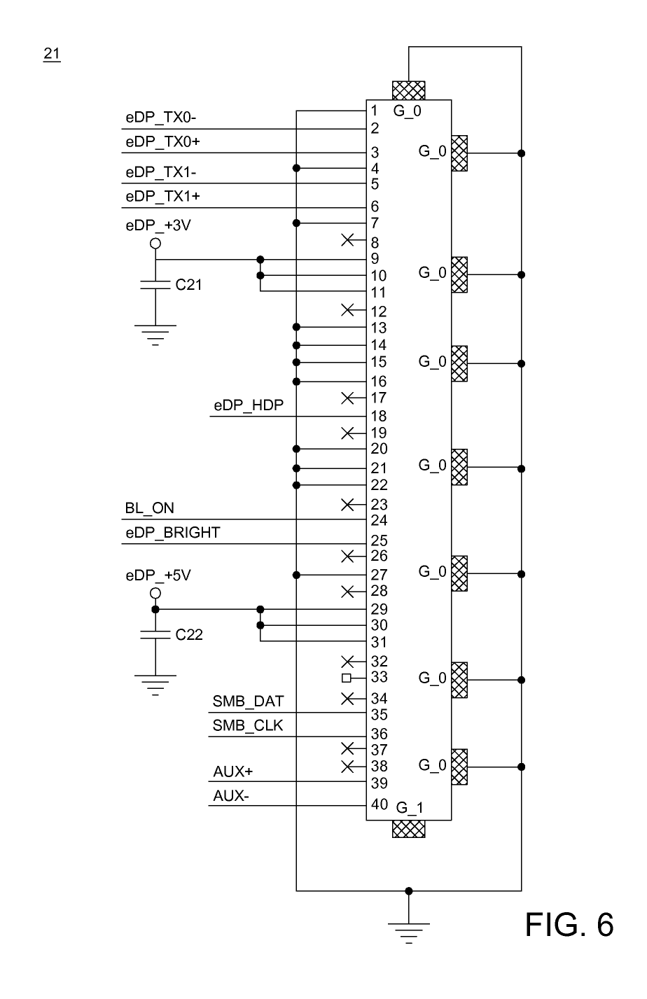

The display unit 201 includes a display (not illustrated) and a display connector 21. The display connector 2, such as a commonly used liquid crystal display (LCD) connector, has 40 pins for receiving the display signal S_eDP provided by the host device 1000 and correspondingly providing a display integrated information In. For example, detailed disposition of the pins of the display connector 21 is illustrated in FIG. 6. The pins 2, 3, 5 and 6 receive the display signal S_eDP. The pin 29 receives the power signal eDP_{—}+5V such as used as a lower supply for the display. The pins 18, 24, 25, 35, 36, 39-40 respectively provide a signal eDP_HDP, a signal BL_ON, a signal eDP_BRIGHT, a signal SMB_DAT, a signal SMB_CLK and an auxiliary display data signal AUX+ and AUX−. The above-mentioned signals provided via pins 18, 24, 25, 35, 36 and 39-40 are associated with the display and are referred as the display integrated information In.

The control unit 203 receives the display integrated information In. The control unit 203 further is programmed, so that when the display device 2000 is connected to a host device (such as the host device 1000) via the USB connector, the control unit 203 provides the product identity S_PID, the vendor identity S_VID and the device descriptions S_DD to inform the host device that the display device 2000 supports VUSB protocol. The product identity S_PID, the vendor identity S_VID and the device descriptions S_DD are transmitted via the USB 2.0 lane.

The control unit 203 further communicates with the host device 1000 via the USB 2.0 lane. When the host device 1000 supports VUSB protocol and the display device 2000 also supports VUSB protocol, the host device 1000 provides a control signal SC via the USB 2.0 lane. The control unit 203 activates the power of the display device 2000 in response to the control signal SC. Then, the host device 1000 further provides the display data S_eDP via the USB 3.0 lane, so that the display unit 201 may correspondingly perform a display operation with respect to the display data S_eDP.

Besides, the control unit 203 further receives the display integrated information In provided by the display unit 201, and sends back the received display integrated information In to the host device 1000 via the USB 2.0 lane. Thus, during the VUSB transmission between the host device and the display device 2000, the control unit 203 further supports the operation of sending back the display integrated information In.

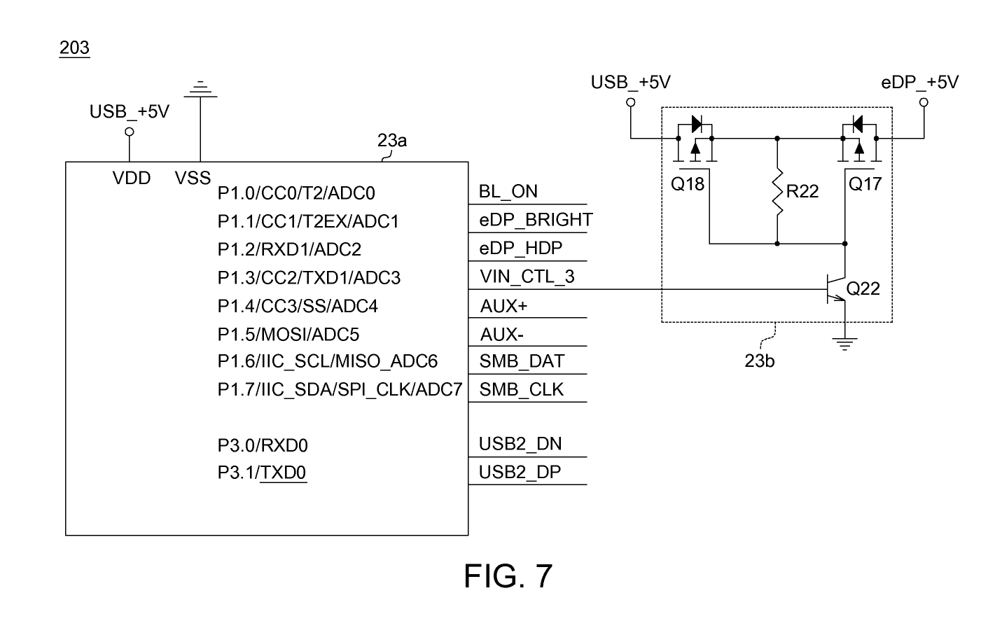

Referring to FIG. 7, a circuit diagram of a control unit 203. For example, the control unit 203 includes a controller 23a and a power supply unit 23b. The power supply unit 23b is realized by transistors Q22, Q17, Q18 and a resistor R22. The transistors Q22 is conducted by the control signal VIN_CTL_3 for providing the power indication signal eDP_{—}+5V according to the USB power supply signal USB_{—}+5V.

The controller 23a is realized by such as an ordinary 8051 chip. The pins P1.0-P1.2 respectively receive the signals BL_ON, eDP_BRIGHT, and eDP_HDP of the display integrated information In. The pins P1.4˜P1.7 respectively receive the auxiliary display data signals AUX+ and AUX− and the signals SMB_DAT and SMB_CLK of the display integrated information In. The pins P 3.0 and P3.1 respectively receive the signals USB2_D+ and USB2_D− transmitted on the USB 2.0 lane. In other words, the control unit 203 provides the product identity S_PID, the vendor identity S_VID, the device descriptions S_DD and the display integrated information In to the host device 1000 via the pins P 3.0 and P3.1, and receives the control signal SC via the same.

On receiving the control signal SC (used for activating the power of the display device 2000), the controller 23a further provides a control signal VIN_CTL_3 via pin P1.3 for conducting the power supply unit 23b to activate the power of the display device 2000.

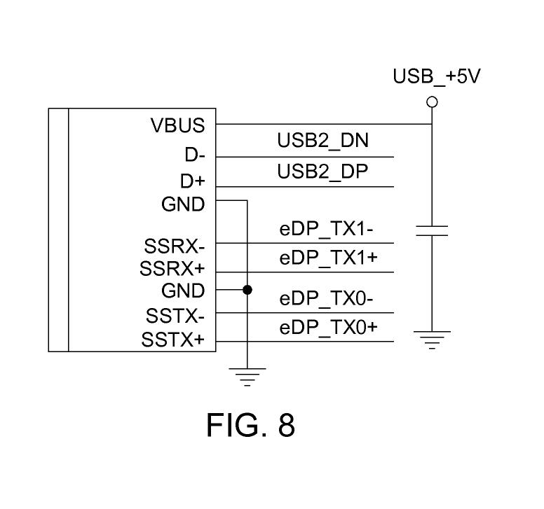

Referring to FIG. 8, a circuit diagram of a slave-end USB connector 205 is shown. Furthermore, the disposition of the pins of the slave-end USB connector 205 corresponds to that of the host-end USB connector 105. Thus, when the slave-end is connected to the host-end USB connectors 205 and 105, the slave-end correspondingly provide a USB 2.0 lane and a USB 3.0 lane between the host device 1000 and the display device 2000 for implementing the transmission operation of data and signals.

### Image Data Transmission Method:

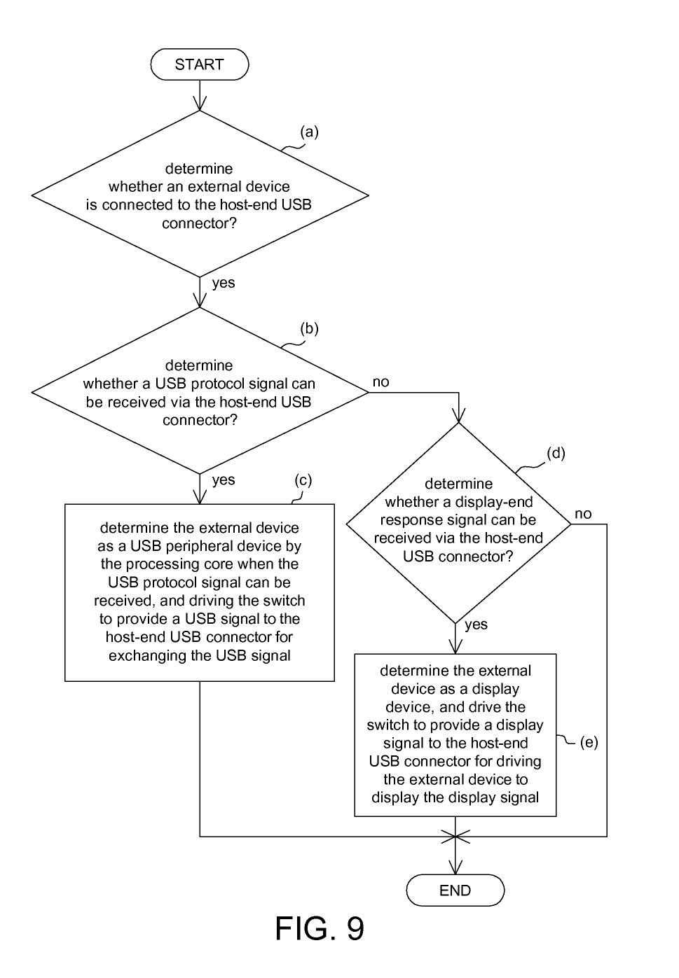

Referring to FIG. 9, a flowchart of an image data transmission method according to an embodiment of the invention is shown. The image data transmission method of the present embodiment of the invention is used in the host device 1000 for implementing the operation of data exchange between the host device 1000 and the display device 2000. The method includes the following steps. Firstly, the method begins at (a), whether an external device is connected to the host-end USB connector 105 is determined by the processing core 101. If so, the method proceeds to step (b), whether a USB protocol signal (such as a signal conformed to USB 3.0 protocol) is received via the host-end USB connector 105 is further determined by the processing core 101.

If the USB protocol signal can be received, then the method proceeds to step (c), the processing core 101 determines the external device as a USB peripheral device, and drives the switch 103 to provide a USB signal S_USB3 to the host-end USB connector 105. Thus, the host device 1000 may exchange USB signal with the USB peripheral device.

Conversely, when the USB protocol signal cannot be received, then the method proceeds to step (d), whether the display-end response signal (such as the product identity S_PID, the vendor identity S_VID and the device descriptions S_DD associated with the display device 2000) is received via the host-end USB connector 105 is determined by the processing core 101. If so, then the method proceeds to step (e), the processing core 101 determines the external device as the display device 2000 supporting VUSB protocol, and drives the switch 103 to provide a display signal s_eDP to the host-end USB connector 105. Thus, the host device 1000 may correspondingly drive the display device 2000 to display the display signal S_eDP.

In an implementation example, step (e) further includes sub-steps (e1) and (e2). In step (e1), the processing core 101 provides a control signal SC for controlling the display device 2000 to boot the system for correspondingly displaying the display signal S_eDP. In step (e2), the display device 2000 further provides an auxiliary display information Into the host device 1000 via the slave-end and the host-end USB connectors 205 and 105.

The host device of the present embodiment of the invention is equipped with a processing core, a switch and a host-end USB connector. When an external device is connected to the host-end USB connector, the processing core determines whether the external device is an ordinary USB peripheral device conformed to USB 3.0 protocol or a display device conformed to VUSB protocol. The processing core makes the above determination by determining whether a signal conformed to USB 3.0 protocol and a signal associated with the VUSB are received via a communication link between the host device and the external device. When the external device is determined as a USB peripheral device or a display device, the processing core respectively controls the switch to provide a USB signal or a display signal to the external device so as to selectively perform the exchange operation of USB data between the host device and the external device and the display operation. In comparison to the conventional computer device, the host device of the present embodiment of the invention effectively uses the USB connector to transmit display data, and implements the multi-functional connector capable of supporting the augmentation of ordinary USB connectors and performing display operation at the same time.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A host device, comprising:
a processing core for providing a display signal and a universal serial bus (USB) signal;
a switch for receiving the display signal and the USB signal; and
a host-end USB connector coupled to the switch and selectively connected to one of a display device and a USB peripheral device, wherein when the host-end USB connector is connected to the display device, the processing core provides a first selection signal for controlling the switch to output the display signal via the host-end USB connector, so that the host device may drive the display device to display the display signal;
wherein, when the host-end USB connector is connected to the USB peripheral device, the processing core provides a second selection signal for controlling the switch to output the USB signal via the host-end USB connector, so that the host device may exchange the USB signal with the USB peripheral device.

2. The host device according to claim 1, further comprising:
a manual switch used for controlling the switch to output the display signal via the host-end USB connector in response to a first user-triggered operation event, wherein the manual switch further controls the switch to output the USB signal via the host-end USB connector in response to a second user-triggered operation event.

3. The host device according to claim 1, wherein the host-end USB connector comprises:
a first USB pin group used for connecting to the switch via a first USB transmission line and receiving the USB signal via same, wherein the processing core determines whether a USB protocol signal is received by the first USB pin group;
wherein, when the USB protocol signal is received by the first USB pin group, the processing core correspondingly determines that the host-end USB connector is connected to the USB peripheral device, and accordingly provides the first selection signal.

4. The host device according to claim 3, wherein the host-end USB connector further comprises:
a second USB pin group connected to the processing core via a second USB transmission line;
wherein, when the signal conformed to USB protocol is not received by the first USB pin group, the processing core determines whether a display-end response signal is received via the second USB pin group;
wherein, when the display-end response signal is received, the processing core correspondingly determines that the host-end USB connector is connected to the display device, and accordingly provides a second selection signal.

5. The host device according to claim 4, wherein the first and the second USB pin group respectively receive the signals conformed to USB 3.0 and USB 2.0 protocols.

6. The host device according to claim 3, wherein the USB protocol signal is conformed to USB 3.0 protocol.

7. A display device, comprising:
a display unit, comprising a display connector for providing a display integrated information;
a control unit coupled to the display connector for receiving the display integrated information; and
a slave-end universal serial bus (USB) connector coupled to the display connector and the control unit and selectively connected to a host device, wherein when the integrated the slave-end connector is connected to the host device, the control unit provides a display-end response signal to the host device according to the display integrated information;
wherein, the host device, in response to the display-end response signal, provides a display signal via the slave-end USB connector for driving the display unit to display the display signal.

8. The display device according to claim 7, wherein the host device, in response to the display-end response signal, further provides a first control signal via the slave-end USB connector, and the control unit, in response to the first control signal, further provides a power indication signal for providing power to the display unit.

9. The display device according to claim 8, wherein the control unit comprises:
a controller for providing a second control signal in response to the first control signal; and
a power supply unit coupled to the slave-end USB connector for receiving a USB power supply signal, wherein the power supply unit, in response to the conduction of the second control signal, further provides a power indication signal according to the USB power supply signal.

10. The display device according to claim 7, wherein the slave-end USB connector comprises:
a first USB pin group connected to the control unit via first USB transmission line for receiving the display integrated information.

11. The display device according to claim 10, wherein the slave-end USB connector further comprises:
a second USB pin group connected to the display connector via the second USB transmission line for providing the display signal to the display unit.

12. The display device according to claim 11, wherein the first USB pin group and the second USB pin group respectively receive a signal conformed to USB 2.0 protocol and a signal conformed to embedded display port (eDP) protocol.

13. An image data transmission method used in a host device comprising a host-end universal serial bus (USB) connector, a switch and a processing core, wherein the image data transmission method comprises:
(a) determining by the processing core whether an external device is connected to the host-end USB connector;
(b) determining by the processing core whether a USB protocol signal is received via the host-end USB connector when the external device is connected to the host-end USB connector;
(c) determining the external device as a USB peripheral device by the processing core when the USB protocol signal can be received, and driving the switch to provide a USB signal to the host-end USB connector, so that the host device may exchange the USB signal with the USB peripheral device;
(d) determining by the processing core whether a display-end response signal is received via the host-end USB connector when the USB protocol signal cannot be received; and
(e) determining the external device as a display device by the processing core when the display-end response signal can be received, and driving the switch to provide a display signal to the host-end USB connector for driving the external device to display the display signal.

14. The data transmission method according to claim 13, wherein step (e) further comprises:
(e1) providing a control signal by the processing core for controlling the switch display device to boot the system to correspondingly display the display signal; and
(e2) providing an auxiliary display information to the host device via the host-end USB connector by the display device.
